(19) United States
(12) Patent Application Publication
(10) Pub. No.: US 2014/0244498 A1
(43) Pub. Date: Aug. 28, 2014

(54) BANK TRANSACTIONS FEED

(71) Applicant: RAWLLIN INTERNATIONAL INC., Tortola (VG)

(72) Inventors: Rodion Shishkov, St. Petersburg (RU); Dmitry Bocharov, St. Petersburg (RU)

(73) Assignee: RAWLLIN INTERNATIONAL INC., Tortola (VG)

(21) Appl. No.: 13/776,969

(22) Filed: Feb. 26, 2013

(51) Int. Cl. G06Q 20/10

(52) U.S. Cl. CPC G06Q 20/108
USPC 705/42

(57) ABSTRACT

Disclosed are electronic systems and techniques for implementing a banking transaction and feed display system are provided that allow a user to visualize and interact with a financial transaction feed displayed on a mobile device. The feed displays a list of transactions made over a defined period of time, and the user selects different views, grouping the financial transactions by type, by recipient, by donor, by amount, and so on. The banking transaction and feed display system provides a rich set of tools to allow the user to customize the views and quickly display a desired format. The system also enables peer to peer payments to contacts stored in an address book on the mobile device.

### TECHNICAL FIELD

The subject disclosure relates generally to financial transactions in a mobile networking environment.

### BACKGROUND

Traditional means of transferring money to friends and family include writing checks, wire transfers, and cash handling. These methods often require making time-consuming trips to banks and other financial institutions to withdraw, deposit, and/or transfer the funds. Web-based bank portals have simplified some of the steps necessary to make bank transfers, but unwieldy and confusing interfaces have hampered their wide-spread adoption. The online banking portals and applications also tend to be stand-alone solutions, and are not well integrated into customer's social networks.

### SUMMARY

Various non-limiting embodiments provide for a banking transaction and feed display system. In an example embodiment, a system comprises a memory storing computer-executable components and a processor communicatively coupled to the memory that executes or facilitates execution of at least one of the computer-executable components. The executable components can include a data retrieval component configured to retrieve financial transaction information relating to a financial transaction. The executable components can also include a contact management component configured to link a payer or payee associated with the financial transaction with a contact stored in an address book on a mobile device. The executable components can also include a presentation component configured to arrange a set of one or more financial transactions for display on a mobile device based on a predetermined criterion, wherein the set of one or more financial transactions includes the financial transaction.

In another example embodiment, a method comprises collecting, by a system including at least one processor, information related to a financial transaction and determining a party to the financial transaction and determining whether the party is associated with contact information accessible by a mobile device. The method can also include organizing a set of one or more financial transactions for display on a mobile device, wherein the set of one or more financial transactions share an attribute, and wherein the set of one or more financial transactions includes the financial transaction.

In another example embodiment, a tangible computer-readable storage device has computer-executable instructions that, in response to execution, cause a system including a processor to perform operations comprising retrieving financial transaction information relating to a payment associated with a financial account. The operations also include linking a participant to the payment with a contact associated with a contact list of a mobile device account. The operations also include displaying information relating to the payment on a mobile device, wherein the information includes identity information associated with the contact, an amount of funds transferred by the payment, and a list of prior payments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of a banking transaction system in accordance with various aspects described herein;

FIG. 2 is a block diagram illustrating an example, non-limiting embodiment of a mobile networking system in accordance with various aspects described herein;

FIG. 3 is a block diagram illustrating an example, non-limiting embodiment of a feed display system in accordance with various aspects described herein;

FIG. 4 is a block diagram illustrating an example, non-limiting embodiment of a feed display system in accordance with various aspects described herein;

FIG. 5 is a block diagram illustrating an example, non-limiting embodiment of a feed display system in accordance with various aspects described herein;

FIG. 6 illustrates a flow diagram of an example, non-limiting embodiment of a method for displaying financial transactions;

FIG. 7 illustrates a flow diagram of an example, non-limiting embodiment of a method for displaying financial transactions;

FIG. 8 illustrates a block diagram of an example electronic computing environment that can be implemented in conjunction with one or more aspects described herein;

FIG. 9 illustrates a block diagram of an example data communication network that can be operable in conjunction with various aspects described herein; and

FIG. 10 illustrates a block diagram of an example mobile device that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, a banking transaction and feed display system is provided that can allows a user to visualize and interact with a financial transaction feed displayed on a mobile device. The feed can display a list of transactions made over a defined period of time, and the user can select different views, grouping the financial transactions by type, by recipient, by donor, by amount, and so on. The banking transaction and feed display system provides a rich set of tools to allow the user to customize the views and quickly display a desired format.

In some embodiments, the system can be implemented on a mobile device, and the mobile device contacts can be associated with the donors/payer or recipient/payees of the financial transactions. Integrating mobile device contacts with the banking transaction system also enables users to send messages and receive messages with the financial transactions. In addition, a log of the messages can be kept and displayed alongside information about the financial transaction. In some embodiments, payments can be made to mobile device contacts, and payments can be received from mobile device contacts via the mobile device. The banking transaction system on the mobile device can communicate with financial institutions to initiate the payments and confirm receipt of payments.

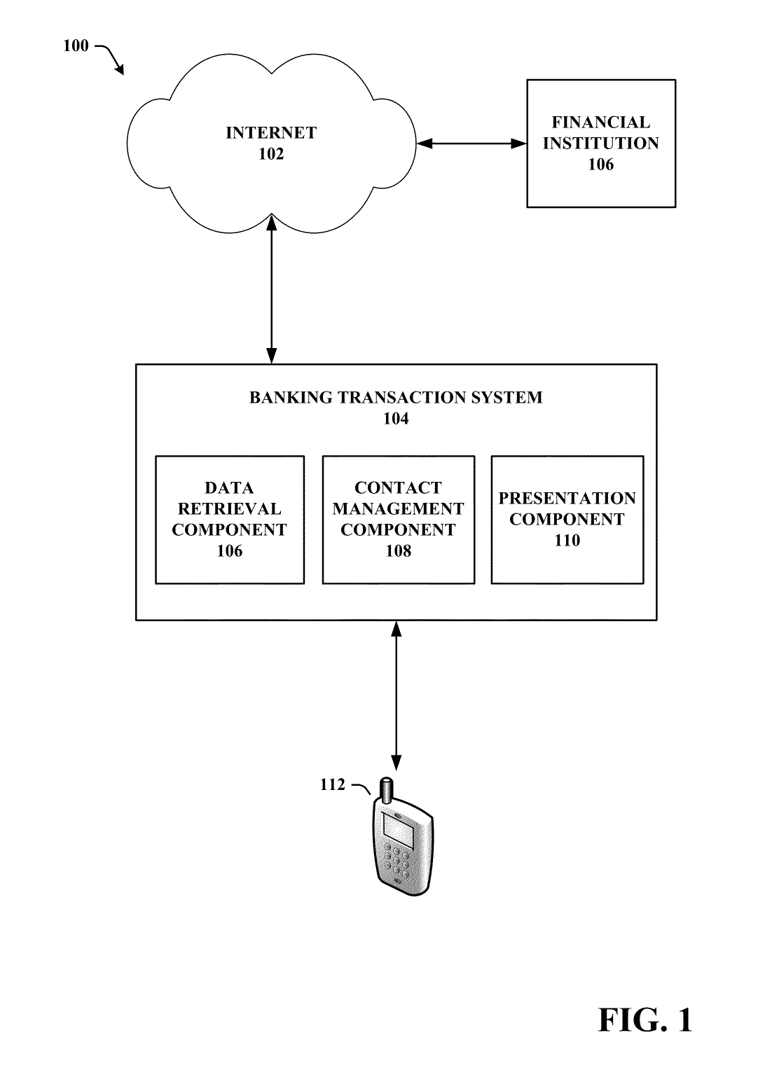

Referring now to FIG. 1, a block diagram illustrating an example, non-limiting embodiment of a banking transaction system in accordance with various aspects described herein is shown. System 100 includes a banking transaction system 104 that includes a data retrieval component 106, a contact management component 108, and a presentation component 110. The banking transaction system 104 can send and receive information via a mobile network to mobile device 112, and can also send and receive information to a financial institution 106 via internet 102.

In some embodiments the banking transaction system 104 can be hosted on servers (not shown) in a mobile network. In this case, the banking transaction system 104 can collect and analyze information remotely, prepare it for presentation and then provide the information for display to the mobile device 112. In other embodiments, the banking transaction system 104 can be installed on the mobile device and components can communicate via a data services (internet connection) with the financial institutions. In still other embodiments, the banking transaction system 104 can be hosted on servers in the cloud and/or associated with the financial institution 106.

The data retrieval component 106 can be configured to retrieve financial transaction information relating to a financial transaction. Data retrieval component 106 can gather information about financial transactions made by a user or associated with a user account. Data retrieval component 106 can determine the user account based on information received from mobile device 112. Mobile device 112 can provide an account number associated with the financial institution 106, and provide a key, password, pass-code, or another form of identification that can authenticate an account. In some embodiments, the mobile device 112 can provide the authentication information in response to the data retrieval component 106 querying the mobile device 112. In other embodiments, the information can be entered manually by the user and transmitted to the data retrieval component 106.

Once data retrieval component 106 has the authentication information, data retrieval component 106 can contact financial institution 106 via the internet 102 to retrieve financial transaction information. Data retrieval component 106 can query financial institution 106 about one or more specific transactions in some embodiments. In other embodiments, data retrieval component 106 can retrieve a set of transactions that fulfill a defined criteria, e.g., transactions made during a period of time, transactions to or from specific people, and etc. In other embodiments, data retrieval component 106 can receive information related to financial transactions on a regular basis, (e.g., daily, weekly, quarterly, etc.) without issuing a query to the financial institution.

The financial transaction information retrieved by data retrieval component 106 can include information identifying the payer and/or payee of the financial transaction, the date and time the transaction was made, the content of messages transferred along with the financial transaction, and the amount of the financial transaction. The information can also include relational information about other financial transactions. Relational information can include for example whether or not the financial transaction was made in response to a previous financial transaction.

Contact management component 108 can be configured to link a payer and/or payee associated with the financial transaction with a mobile device contact. Using the financial transaction information retrieved by data retrieval component 106, contact management component 108 can compare the payers and payees of the financial transactions to contacts associated with mobile device 112. Contact management component 108 can compare names, phone numbers, email addresses, and/or other identifying information to determine whether the payer and/or payees are also mobile device contacts.

Contact management component 108 can use mobile device contact information stored on the mobile device 112 in some embodiments, and can use mobile device contact information stored in the cloud, or on the mobile network servers in other embodiments. Contact management component 108 can also match the payers and/or payees to contact information from an email account associated with a user of mobile device 112.

The contact management component 108 can also facilitate transfer of payments between contacts. Contact management component 108 can facilitate peer to peer payments to contacts associated with the mobile device 112. Contact management component 108 can also facilitate transferring funds to financial institutions associated with the mobile device contacts. To accomplish this, contact management component 108 can determine which financial institutions are associated with the mobile device contacts and other information that can be used to facilitate payment transfer.

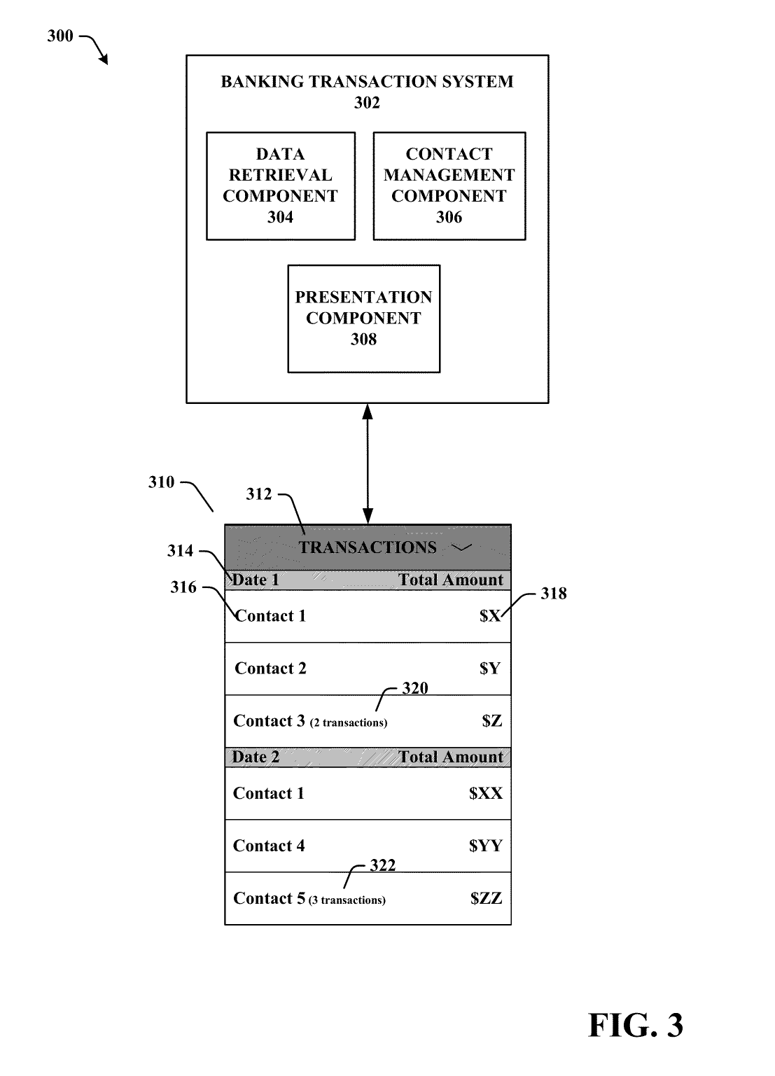

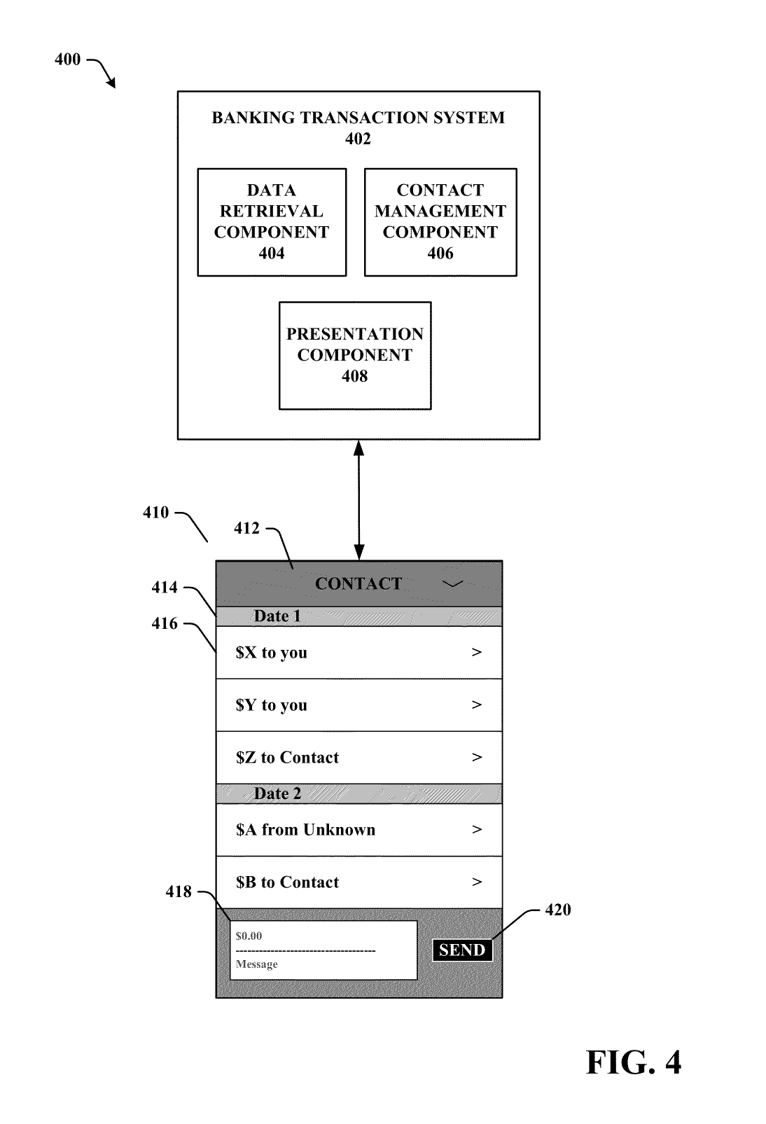

Presentation component 110 can be configured to arrange a set of one or more financial transactions for display on the mobile device 112 based on a predetermined criterion, wherein the set of one or more financial transactions includes the financial transaction. Presentation component 110 can organize the display of financial transaction information based on settings and/or feedback received from the mobile device 112. Presentation component 110 can arrange the financial transactions according to a predefined default setting, and then re-organize the display based on selections received from the mobile device 112. In some embodiments, the presentation component can arrange the financial transactions chronologically (see FIG. 3), and in other embodiments, presentation component 110 can arrange the financial transactions by transaction type or by contact (see FIG. 4).

The presentation component 110 can also display information relating to the payer/payee of the financial transaction, the type of transaction, date and time of the transaction and/or the amount of the transaction. The presentation component 110 can display information that was retrieved by the data retrieval component 106. In some embodiments, presentation component 110 can receive a selection to display information that was not initially retrieved by the data retrieval component 106. Data retrieval component 106 can then retrieve the additional information from the financial institution 106.

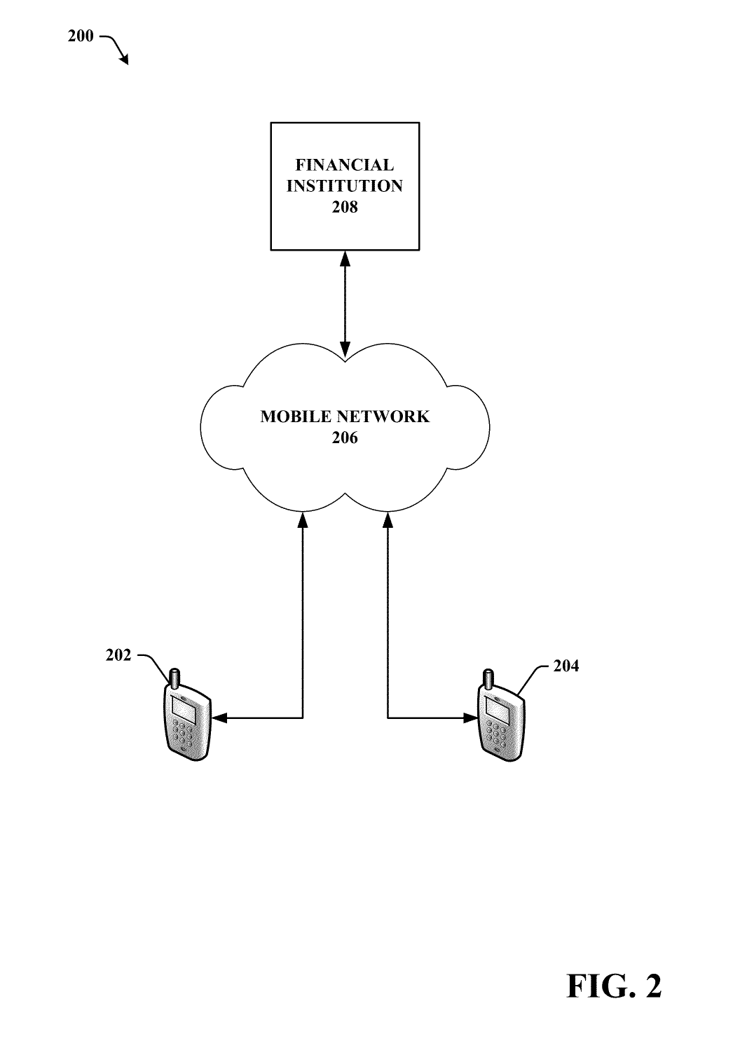

Turning now to FIG. 2, a block diagram illustrating an example, non-limiting embodiment of a mobile networking system in accordance with various aspects described herein is shown. System 200 includes mobile devices 202 and 204 that can communicate with each and with a financial institution 208 via mobile network 206.

Mobile devices 202 and 204 are linked via the same mobile network in this example, but in other embodiments, mobile devices 202 and 204 can each receive service via separate mobile networks. Mobile device 202 can transfer funds to mobile device 204 by initiating payment via a contact management component (e.g., contact management component 108) in a banking transaction system. In response to the mobile device 202 initiating the payment transfer, the banking transaction system can send a request to the financial institution 208 to transfer funds from an account associated with a user of mobile device 202 to an account associated with a user of mobile device 204.

It is to be appreciated that in other embodiments, mobile devices 202 and 204 can be associated with different financial institutions. Payments from accounts associated with mobile devices 202 and 204 are thus made from one financial institution to another. In other embodiments, payments may be made directly from mobile device 202 to mobile device 204 via peer to peer payments. Bluetooth, wireless, and other near field communications technologies can facilitate these peer to peer transactions.

Turning now to FIG. 3, shown is a block diagram of an example, non-limiting embodiment of a feed display system in accordance with various aspects described herein. System 300 includes a banking transaction system 302 with a data retrieval component 304, a contact management component 306, and a presentation component 308. The banking transaction system 302 can facilitate the display of a feed of financial transactions on a mobile device display 310.

Data retrieval component 304 can be configured to retrieve financial transaction information relating to a financial transaction. Data retrieval component 304 can gather information about financial transactions made by a user or associated with a user account from a financial institution. The data retrieval component 304 can also receive information about the financial transactions from the mobile device as well. Once contact management component 306 has linked together the payer and/or payee with contacts associated with the mobile device, presentation component 308 can display a feed of financial transactions.

In one embodiment, shown in FIG. 3, the presentation component 308 can arrange the financial transactions chronologically. A header bar 312 can show the display selection, and in this embodiment, it is by transaction. Another header bar 314 at the top of a group of transactions can provide the date of the group of transactions as well as the total amount of funds transferred on that date. The amount of funds transferred can have a negative or positive value depending on whether there was a net transfer or net intake of funds respectively. The first set of financial transactions displayed are all the financial transactions that occurred on the date specified in the header bar 314. An exemplary transaction has displayed on the left side (316) the contact (Contact 1) that was a party to the transaction. On the right side (318) the amount of the transaction ($X) is listed. All of the transactions that occurred on Date 1 can be listed in such a manner, and similarly, the transactions that occurred on Date 2 can be listed as well.

In some embodiments, different configurations can be implemented. For instance, the financial transactions can be arranged chronologically with the most recent transactions at the top, and in other configurations the most recent transactions can be listed in descending order. Similarly, the amount transferred can be displayed on the left or the right. The presentation component 308 can arrange these different configurations based on feedback received via the mobile device. Users can select different options for how they prefer the screen to be organized or displayed, and based on these selections, presentation component 308 can adjust the display.

If there have been multiple transactions on the same day between the same parties, an indication 320 and 322 of how many transactions have taken place can be displayed. In other embodiments, rather than being grouped, each transaction with the same party on the same day can be listed separately.

Selecting one of the financial transactions can cause presentation component 308 to open a new window, or display on the screen, additional information about the transaction. Such additional information can include financial institution account numbers associated with the transaction, a description of the transaction, any messages transferred between the users when executing the transaction, and etc. Selecting the name of the contact can cause the presentation component 308 to display the set of financial transactions between the contact and the user. Selecting the header bar with the dates can open up a menu allowing the user to select a different range of dates from which to display financial transactions. Similarly, selections can be made to group transactions by the amount transferred, in ascending or descending order.

Turning now to FIG. 4, a block diagram illustrating an example, non-limiting embodiment of a feed display system in accordance with various aspects described herein is shown. System 400 includes a banking transaction system 402 with a data retrieval component 404, a contact management component 406, and a presentation component 408. The banking transaction system 402 can facilitate the display of a feed of financial transactions on a mobile device display 410.

Data retrieval component 404 can be configured to retrieve financial transaction information relating to a financial transaction. Data retrieval component 404 can gather information about financial transactions made by a user or associated with a user account from a financial institution. The data retrieval component 404 can also receive information about the financial transactions from the mobile device as well. Once contact management component 406 has linked together the payer and/or payee with contacts associated with the mobile device, presentation component 408 can display a feed of financial transactions.

In the embodiment shown in FIG. 4, the presentation component 408 can display a list of transactions to and from a single contact. A header bar 412 can show the name of the contact and from a drop down menu on the header bar 412, different contacts can be selected. The financial transactions to and from the contact can then be grouped by date, as header bar 414 shows. The financial transaction 416 that is displayed can then specify the amount that was transferred, as well as whether the financial transaction 416 was incoming or outgoing. In some embodiments, the financial transaction 416 can include information describing the transaction. The description can incorporate contents of messages that were sent between the user and the contact or can include descriptions entered by the user.

In some embodiments, different configurations can be implemented. For instance, the financial transactions can be arranged chronologically with the most recent transactions at the top, and in other configurations the most recent transactions can be listed in descending order. Similarly, the amount transferred can be displayed on the left or the right. The presentation component 408 can arrange these different configurations based on feedback received via the mobile device. Users can select different options for how they prefer the screen to be organized or displayed, and based on these selections, presentation component 408 can adjust the display accordingly.

When the presentation component 408 displays the contact tab 412, a transaction window 418 can also be presented on the display 410. The transaction window can include an area where a transfer amount can be entered and also an area where a message can be composed to accompany the transfer. The message can indicate to the recipient what the payment is for as well as other descriptive information. A button 420 can be shown also, and the payment is transferred and the message is sent when the button 420 is executed.

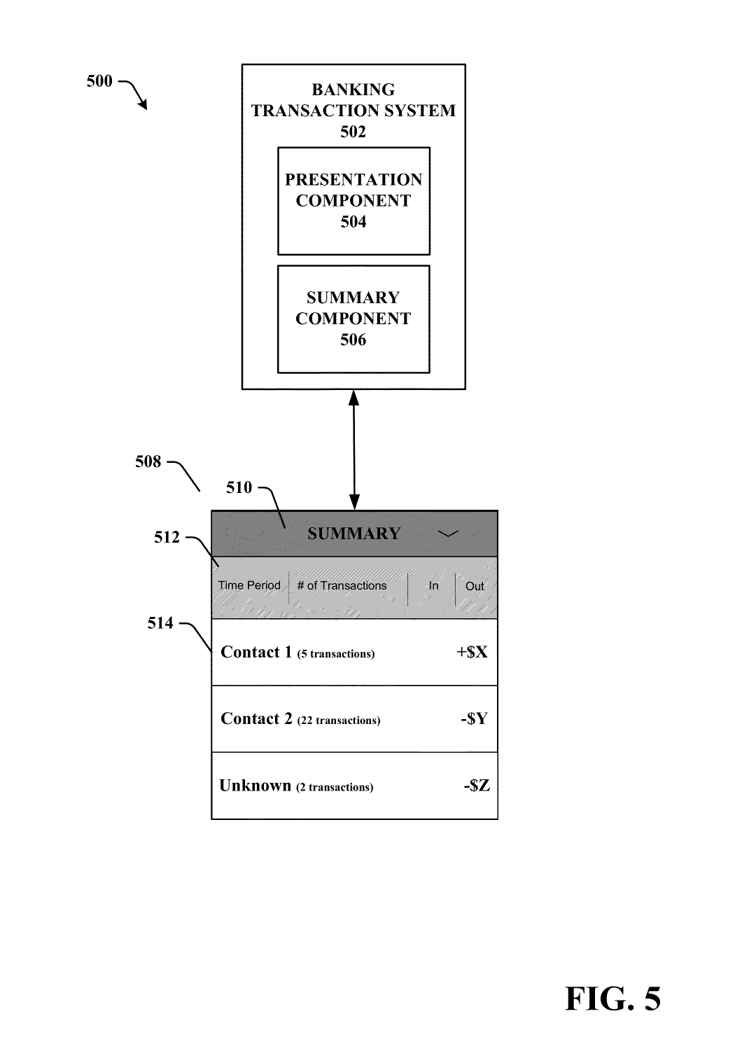

Turning now to FIG. 5, a block diagram illustrating an example, non-limiting embodiment of a feed display system in accordance with various aspects described herein is shown. System 500 includes a banking transaction system 502 with a presentation component 504 and a summary component 506. The banking transaction system 502 can facilitate the display of a feed of financial transactions on a mobile device display 508.

Summary component 506 can prepare a summary of past financial transactions based on selections received from the mobile device and presentation component 504 can prepare the summaries for display on the mobile device. The summary page can be selected by selecting the summary tab 510 on the mobile device display 508.

In one embodiment, a default view of the summary page shows a list of transactions 514 that contain details such as the payer and/or payee, the number of transactions, and the amount of funds transferred. A header bar 512 above the list of transactions 514 provides a summary of the transactions for a given time period. The summary can include the total number of transactions, the number of contacts that have been involved in financial transactions, the amount of funds transferred in and out, as well as a balance of funds in an associated account at a financial institution. Selecting one of the items in the header bar 512 allows the summary page to be customized, such as changing the time period for which to show the summary, ranking transactions in ascending or descending order based on the name of the contact, amount of money transferred, type of transaction, and so forth.

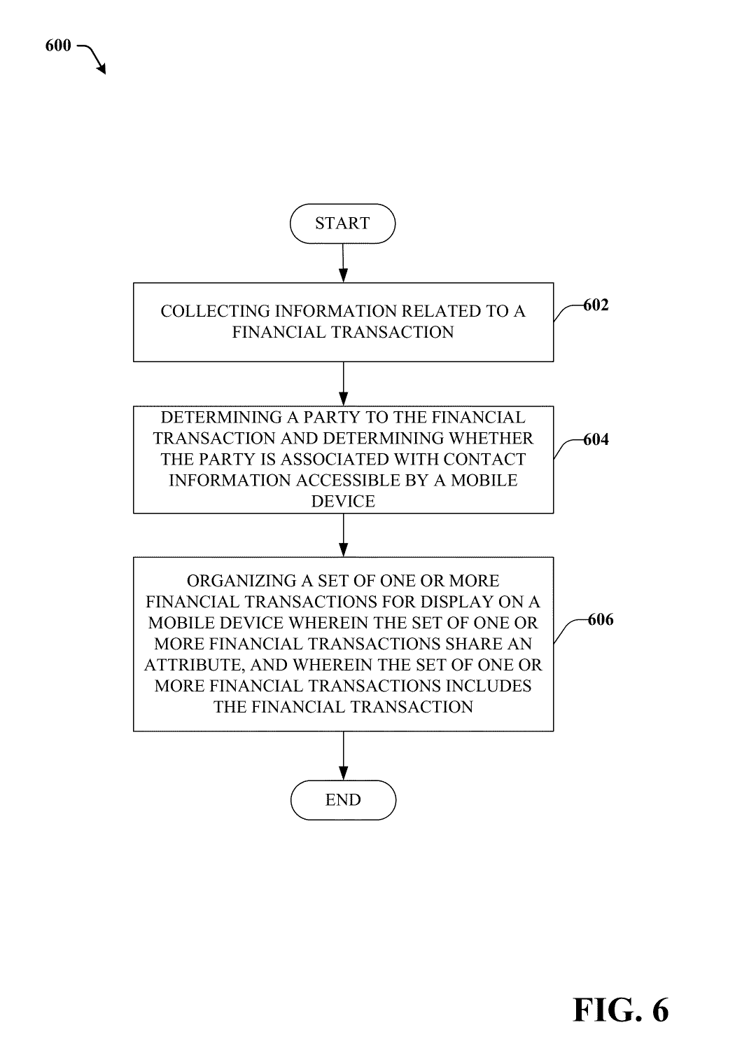

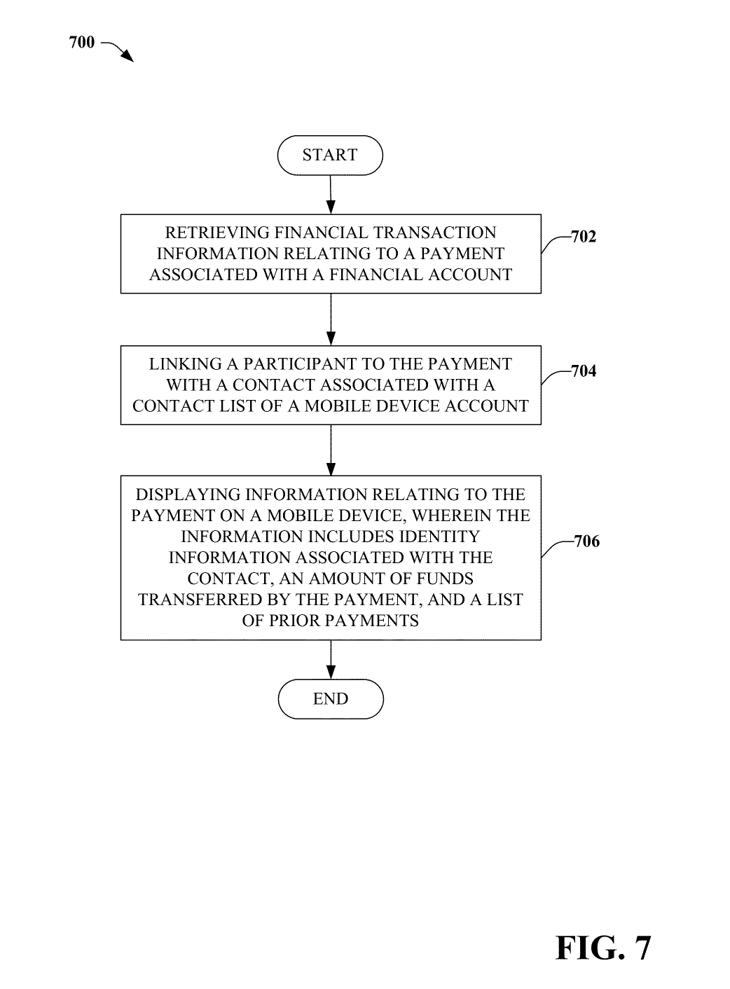

In view of the example systems described above, methods that may be implemented in accordance with the described subject matter may be better appreciated with reference to the flow charts of FIGS. 6 and 7. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, illustrated is an example methodology 600 that illustrates a flow diagram of an example, non-limiting embodiment of a method for displaying financial transactions. At 602, information related to a financial transaction can be collected. A data retrieval component (e.g., data retrieval component 106) can retrieve information about financial transactions made by a user or associated with a user account. The data retrieval component can determine the user account based on information received from a mobile device. The mobile device can provide an account number associated with the financial institution, and provide a key, password, pass-code, or another form of identification that can authenticate an account.

Once the data retrieval component has the authentication information, the data retrieval component can contact the financial institution to retrieve financial transaction information. The data retrieval component can query the financial institution about one or more specific transactions in some embodiments. In other embodiments, the data retrieval component can retrieve a set of transactions that fulfill a defined criteria, e.g., transactions made during a period of time, transactions to or from specific people, and etc. In other embodiments, the data retrieval component can receive information related to financial transactions on a regular basis, (e.g., daily, weekly, quarterly, etc.) without issuing a query to the financial institution.

At 604, a party to the financial transaction can be determined, and it can also be determined whether the party is associated with contact information accessible by a mobile device. Using the financial transaction information retrieved by the data retrieval component, a contact management component (e.g., contact management component 108) can compare the payers and payees of the financial transactions to contacts associated with the mobile device. The contact management component can compare names, phone numbers, email addresses, and/or other identifying information to determine whether the payer and/or payees are also mobile device contacts.

At 606, a set of one or more financial transactions can be organized for display on a mobile device, wherein the set of one or more financial transactions share an attribute, and wherein the set of one or more financial transactions includes the financial transaction. A presentation component (e.g., presentation component 110) can to arrange a set of one or more financial transactions for display on the mobile device based on a predetermined criterion, wherein the set of one or more financial transactions includes the financial transaction. The presentation component can organize the display of financial transaction information based on settings and/or feedback received from the mobile device. The presentation component can arrange the financial transactions according to a predefined default setting, and then re-organize the display based on selections received from the mobile device.

Referring to FIG. 7, illustrated is an example methodology 600 that illustrates a flow diagram of an example, non-limiting embodiment of a method for displaying financial transactions. At 702, financial transaction information relating to a payment associated with a financial account can be retrieved. The information can be retrieved from the financial institution associated with the financial account.

At 704, a participant to the payment can be linked with a contact associated with a contact list of a mobile device account. At 706, information relating to the payment can be displayed on a mobile device, wherein the information includes identity information associated with the contact, an amount of funds transferred by the payment, and a list of prior payments.

### Example Computing Environment

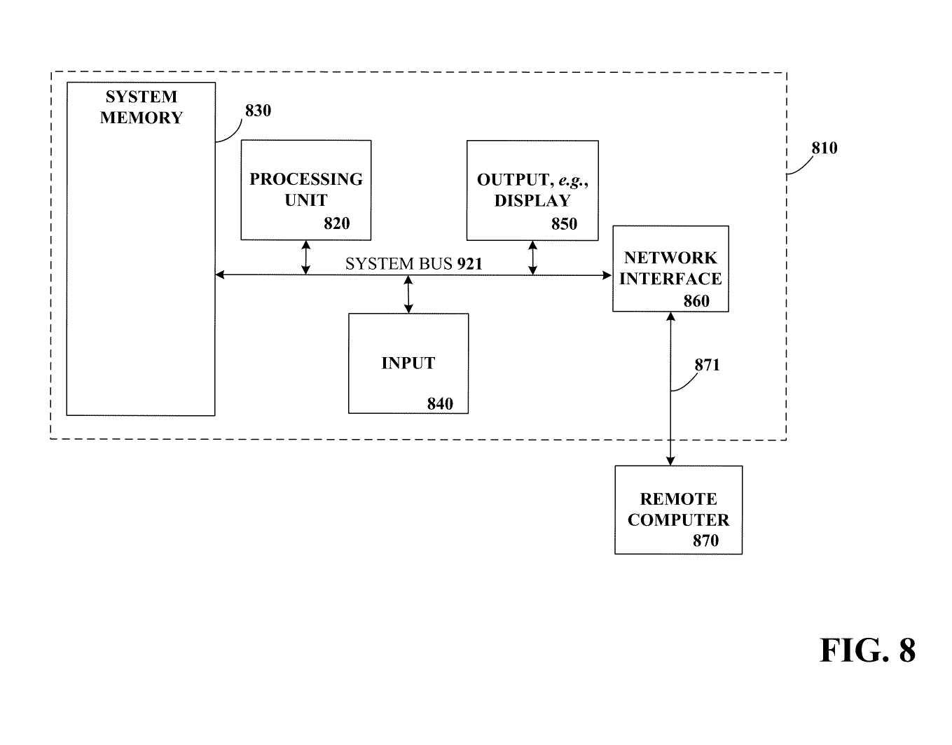

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 8 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 8 thus illustrates an example of a suitable computing system environment 800 in which some aspects of the disclosed subject matter can be implemented, although as made clear above, the computing system environment 800 is only one example of a suitable computing environment for a device and is not intended to suggest any limitation as to the scope of use or functionality of the disclosed subject matter. Neither should the computing environment 800 be interpreted as having any dependency or requirement relating to any one or combination of components illustrated in the exemplary operating environment 800.

With reference to FIG. 8, an exemplary device for implementing the disclosed subject matter includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules, or other data in a modulated data signal such as a carrier wave or other transport mechanism and includes any information delivery media.

The system memory 830 may include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, may be stored in memory 830. Memory 830 typically also contains data and/or program modules that are immediately accessible to and/or presently being operated on by processing unit 820. By way of example, and not limitation, memory 830 may also include an operating system, application programs, other program modules, and program data.

The computer 810 may also include other removable/non-removable, volatile/nonvolatile computer storage media. For example, computer 810 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 821 through a non-removable memory interface such as an interface, and a magnetic disk drive or optical disk drive is typically connected to the system bus 821 by a removable memory interface, such as an interface.

A user can enter commands and information into the computer 810 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 820 through user input 840 and associated interface(s) that are coupled to the system bus 821, but may be connected by other interface and bus structures, such as a parallel port, game port, or a universal serial bus (USB). A graphics subsystem can also be connected to the system bus 821. A projection unit in a projection display device, or a HUD in a viewing device or other type of display device can also be connected to the system bus 821 via an interface, such as output interface 850, which may in turn communicate with video memory. In addition to a monitor, computers can also include other peripheral output devices such as speakers which can be connected through output interface 850.

The computer 810 can operate in a networked or distributed environment using logical connections to one or more other remote computer(s), such as remote computer 870, which can in turn have media capabilities different from device 810. The remote computer 870 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 810. The logical connections depicted in FIG. 8 include a network 871, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 810 can be connected to the LAN 871 through a network interface or adapter. When used in a WAN networking environment, the computer 810 can typically include a communications component, such as a modem, or other means for establishing communications over the WAN, such as the Internet. A communications component, such as wireless communications component, a modem and so on, which can be internal or external, can be connected to the system bus 821 via the user input interface of input 840, or other appropriate mechanism. In a networked environment, program modules depicted relative to the computer 810, or portions thereof, can be stored in a remote memory storage device. It will be appreciated that the network connections shown and described are exemplary and other means of establishing a communications link between the computers can be used.

### Example Networking Environment

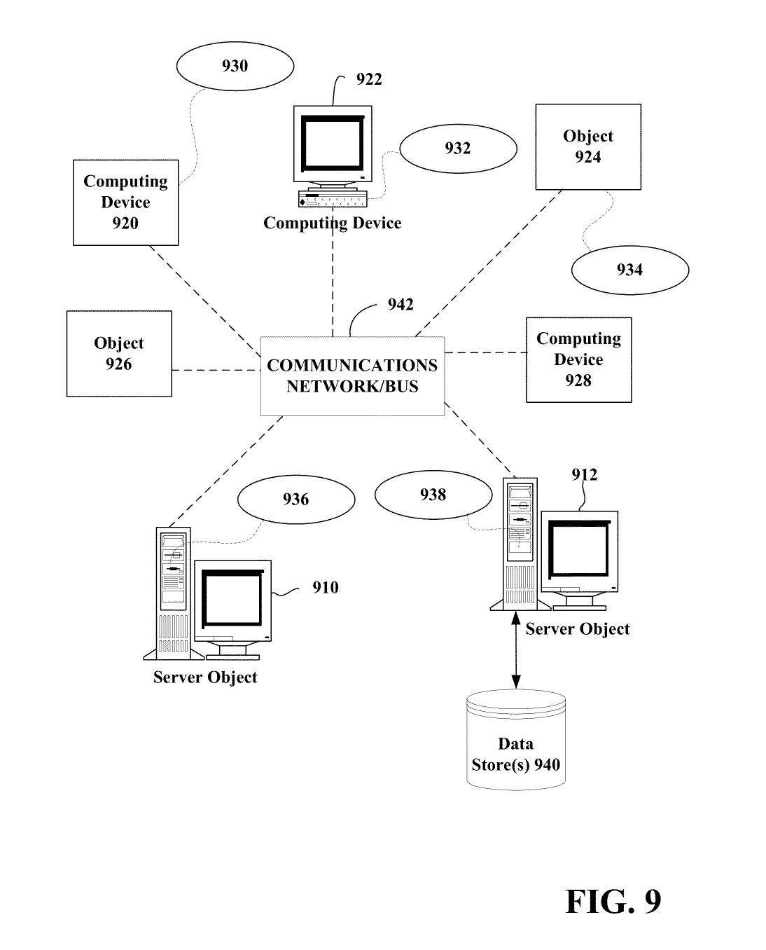

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938 and data store(s) 940. It can be appreciated that computing objects 910, 912, etc. and computing objects or devices 920, 922, 924, 926, 928, etc. may comprise different devices, including mobile device 110 or similar devices depicted within the illustrations, personal digital assistant (PDA), audio/video device, MP3 players, personal computer, laptop, etc. It should be further appreciated that data store(s) 940 can include other similar data stores disclosed herein.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 942, either directly or indirectly. Even though illustrated as a single element in FIG. 9, communications network 942 may comprise other computing objects and computing devices that provide services to the system of FIG. 9, and/or may represent multiple interconnected networks, which are not shown. Each computing object 910, 912, etc. or computing object or devices 920, 922, 924, 926, 928, etc. can also contain an application, such as applications 930, 932, 934, 936, 938, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 942 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

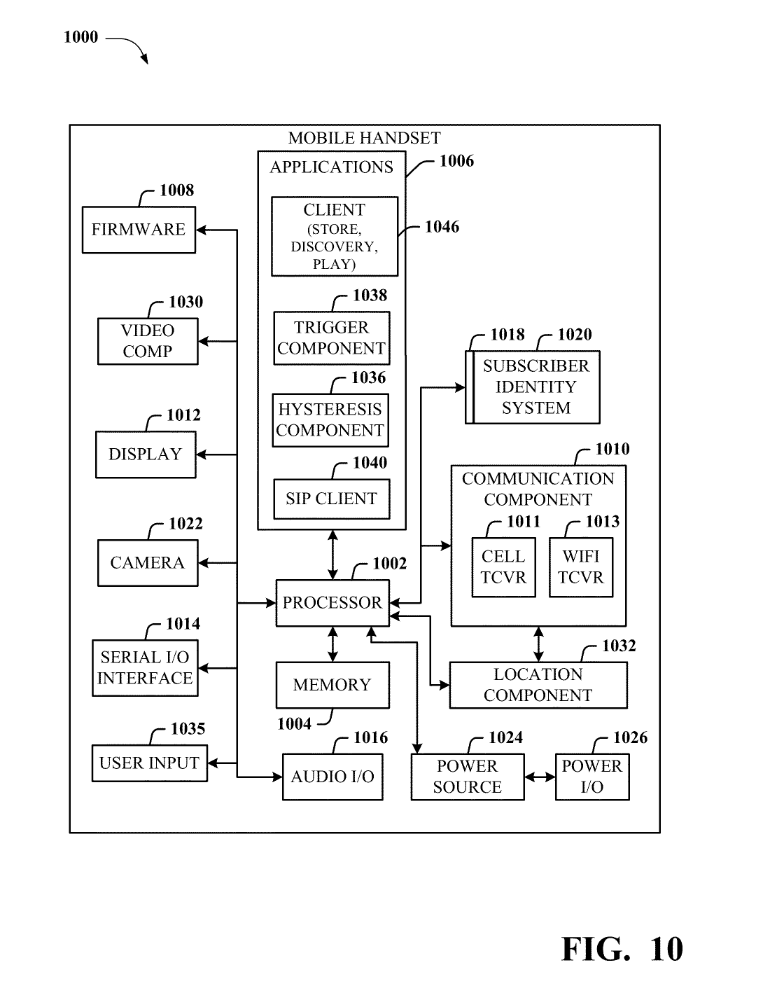

FIG. 10 illustrates a schematic block diagram of an exemplary device 1000 capable of employing the subject system in accordance with some embodiments of the invention. The device is a mobile handset 1000 In order to provide additional context for various aspects thereof, FIG. 10 and the following discussion are intended to provide a brief, general description of a suitable environment 1000 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, . . . ). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and an unlicensed transceiver 1013 (e.g., WiFi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. The display 1012 can also accommodate the presentation of multimedia content (e.g., music metadata, messages, wallpaper, graphics, . . . ). A serial I/O interface 1014 is provided in communication with the processor 1002 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software thereto.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 1000 and IP-based multimedia content can be received in either an encoded or decoded format.

A video processing component 1022 (e.g., a camera) can be provided for decoding encoded multimedia content. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. A location tracking component 1032 facilitates geographically locating the handset 1000. As described hereinabove, this can occur when the user initiates the feedback signal automatically or manually. A user input component 1034 facilitates the user initiating the quality feedback signal. The input component can include such conventional input device technologies such as a keypad, keyboard, mouse, stylus pen, and touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the WiFi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 1010, includes an indoor network radio transceiver 1013 (e.g., WiFi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers. Further, these components can execute from various non-transitory computer-readable media having various data structures stored thereon. In this regard, the terms “non-transitory” and “tangible” herein as applied to storage, memory or computer-readable media, is to be understood to exclude only propagating transitory signals per se as a modifier and does not relinquish all standard storage, memory or computer-readable media that are not only propagating transitory signals per se.

The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

1. A mobile device, comprising:
a memory to store executable components; and
a processor, coupled to the memory, that executes or facilitates execution of at least one of the executable components, the executable components comprising:
a data retrieval component configured to retrieve financial transaction information relating to a financial transaction;
a contact management component configured to link a payer or payee associated with the financial transaction with a messaging contact of a set of messaging contacts used for messages sent to the set of contacts or received from the set of messaging contacts by the mobile device; and
a presentation component configured to arrange a set of financial transactions and a set of messages sent to or received from the set of messaging contacts for display on the mobile device based on a criterion, wherein the set of financial transactions comprises the financial transaction.

2. The mobile device of claim 1, wherein the presentation component is further configured to rearrange the set of financial transactions displayed on a display screen of the mobile device based on a selection received via the mobile device that adds another criterion to a set of criteria comprising the criterion, changes the criterion, or removes the criterion from the set of criteria.

3. The mobile device of claim 1, wherein the presentation component is further configured to display information relating to an identity of at least one of the payer or payee of the financial transaction, a date of the financial transaction, a time of the financial transaction, or a payment amount of the financial transaction.

4. The mobile device of claim 1, wherein the presentation component is further configured to arrange the set of financial transactions by at least one of a date associated with the financial transaction, the messaging contact associated with the financial transaction, or a type of the financial transaction.

5. The mobile device of claim 1, wherein the contact management component is configured to facilitate, via a messaging application of the mobile device based on the messaging contact, sending of messages to the payer or payee relating to the financial transaction, and receiving of other messages relating to the financial transaction from the payer or payee.

6. The system of claim 5, wherein the presentation component is further configured to display a log of one or more messages comprising a history of messages sent to or received from the payer or payee based on the messaging contact.

7. The mobile device of claim 5, wherein the contact management component is further configured to facilitate a message sent via the messaging application based on the messaging contact indicating a receipt of payment or a transfer of the payment from the payer or payee.

8. The mobile device of claim 1, wherein the presentation component is further configured to display a log of financial transactions of the set of financial transactions that are associated with the messaging contact, wherein the log comprises information representing a balance of payments transferred to or from the messaging contact.

9. The mobile device of claim 8, wherein the log displays messages and payments associated with the messaging contact for a time period represented by the financial transactions, and the time period is based on a selection received by the mobile device.

10. The mobile device of claim 1, wherein the executable components further comprise a summary component that prepares a summary of past financial transactions with the payee or the payer in response to a selection of one of the set of financial transactions.

11. The mobile device of claim 1, wherein the presentation component is configured to display a balance of funds in a financial account associated with the mobile device.

12. A method, comprising:
collecting, by a device comprising at least one processor, information related to a financial transaction;
determining, by the device, a party to the financial transaction;
determining, by the device, whether the party is associated with a messaging contact of a set of messaging contacts associated with an address book of a mobile device; and
organizing, by the device, a set of financial transactions and a set of messages sent to or received from the set of messaging contacts for display on the mobile device, wherein the set of financial transactions and the set of messages share an attribute related to a criterion, and the set of financial transactions comprises the financial transaction, and wherein an organization of the set of financial transactions and the set of messages is based on the criterion.

13. The method of claim 12, further comprising:
modifying, by the device, an organization of the set of financial transactions in response to feedback received via the mobile device that adds another criterion to a set of criteria comprising the criterion, changes the criterion, or removes the criterion from the set of criteria.

14. The method of claim 12, further comprising:
displaying, by the device, information relating to a payment amount of the financial transaction, a date of the financial transaction, a time of the financial transaction, and an identity of the party associated with the financial transaction.

15. The method of claim 12, further comprising:
arranging, by the device, the set of financial transactions by at least one of a date associated with the financial transaction, a messaging contact associated with the financial transaction, and a type of the financial transaction.

16. The method of claim 12, further comprising:
sending, by the device, a notification of a payment to a recipient; and
attaching, by the device, a message for the recipient to the notification.

17. The method of claim 12, further comprising:
displaying, by the device, a log of financial transactions of the set of financial transactions associated with the messaging contact, wherein the log comprises a balance of payments transferred to or from the messaging contact; and
organizing, by the device, the log of financial transactions based on feedback received from the mobile device.

18. A tangible computer-readable storage device comprising executable instructions that, in response to execution, cause a system comprising a processor to perform operations, comprising:
retrieving financial transaction information relating to a payment associated with a financial account;
linking a participant to the payment with a messaging contact of a set of messaging contacts used for messages sent to the set of contacts or received from the set of messaging contacts, wherein the set of messaging contacts are associated with a contact list of a mobile device account; and
displaying information relating to the payment and a set of messages sent to or received from the set of messaging contacts on a mobile device, wherein the information comprises identity information associated with the messaging contact, an amount of funds transferred by the payment, and a list of prior payments.

19. The tangible computer-readable storage device of claim 18, wherein the operations further comprise:
modifying an organization of the information displayed on the mobile device in response to feedback received via the mobile device.

20. The tangible computer-readable storage device of claim 18, wherein the operations further comprise:
arranging the information associated with the payment and the list of payments by at least one of a date associated with the payment, dates associated with the list of prior payments, an identity of the party associated with the payments, and a type of the payments.
